(19) United States
(12) Patent Application Publication
(10) Pub. No.: US 2026/0155575 A1
(43) Pub. Date: Jun. 4, 2026

(54) ULTRA-FLAT 2X2 MIMO BROADBAND ANTENNA

(71) Applicant: JOHN MEZZALINGUA ASSOCIATES, LLC., Liverpool, NY (US)

(72) Inventors: Lance BAMFORD, Pittsford, NY (US); Jeremy BENN, Liverpool, NY (US)

(21) Appl. No.: 19/122,991

(22) PCT Filed: Oct. 31, 2023
(86) PCT No.: PCT/US2023/036415

§ 371 Date: Apr. 21, 2025

Related U.S. Application Data
(60) Provisional application No. 63/420,729, filed on Oct. 31, 2022.

(51) Int. Cl. H01Q 13/08; H01Q 5/30; H01Q 21/28; H01Q 25/00; H04B 7/0413

(52) U.S. Cl. CPC H01Q 13/085; H01Q 5/30; H01Q 21/28; H01Q 25/005; H04B 7/0413

(57) ABSTRACT

An ultra-flat 2×2 MIMO ultra-flat broadband antenna has a first signal radiator and a second signal radiator, wherein the first signal radiator and second signal radiators respectively form a first Vivaldi radiator and a second Vivaldi radiator, wherein the first Vivaldi radiator and the second Vivaldi radiator radiate in opposite directions. The first signal radiator has a first signal first radiator and a first signal second radiator that are coupled together by a first conductive channel; and the second signal radiator has a second signal first radiator and a second signal second radiator that are coupled together by a second conductive channel. The first signal first radiator has a shape that substantially mirrors the shape of the second signal first radiator, and the first signal second radiator has a shape that substantially mirrors the shape of the second signal second radiator.

### BACKGROUND OF THE DISCLOSURE

### Field of the Invention

The present invention relates to wireless communications, and more particularly, to compact broadband antennas intended for indoor deployments.

### Related Art

It has been determined that the majority of cellular data usage demanding high data rates-and thus high bandwidth-occurs within buildings. Further, with the advent of 5G, demand for high data rates may be accommodated by using higher RF frequencies. For example, the designated 5G mid band occupies RF spectrum from 0.617 GHz to 6 GHz. Although the higher frequency bands provide for very high data rates, radio propagation in these frequency bands can be hampered by obstacles and intervening structures. Overcoming this shortcoming requires network operators to deploy numerous antennas to assure continuous coverage. This problem is particularly acute within buildings.

Conventional antennas suffer certain deficiencies that prevent them from adequately servicing mid band 5G frequencies in indoor settings: conventional antennas are cumbersome and are difficult to deploy within buildings in such a way as to blend into their environment; and conventional antennas typically do not provide for adequate performance in the broad mid band range.

Further, a key feature of 5G is its MIMO (Multi Input Multi Output) capabilities, which includes 2×2 MIMO, 4×4 MIMO, 16×16 MIMO, etc. For in-building deployments, this becomes particularly challenging because, for example, a 2×2 MIMO in-building antenna requires two radiators and two ports. This complicates design of an antenna that is intended to be as inobtrusive as possible.

Accordingly, what is needed is a broadband antenna that performs well in the 5G mid band frequency range yet is sufficiently thin and compact to be deployed throughout an indoor environment in such a way that they are easy to install and unobtrusive.

### SUMMARY OF THE DISCLOSURE

An aspect of the disclosure involves an antenna. The antenna comprises a first signal radiator disposed on a substrate, the first signal radiator having a first signal first radiator and a first signal second radiator, wherein the first signal first radiator and the first signal second radiator form a first Vivaldi radiator; and a second signal radiator disposed on the substrate, the second signal radiator having a second signal first radiator and a second signal second radiator, wherein the second signal first radiator and the second signal second radiator form a second Vivaldi radiator.

### BRIEF DESCRIPTION OF THE DRAWINGS

FIG. 1 illustrates an exemplary ultra-flat 2×2 MIMO broadband antenna according to the disclosure.

FIG. 2 is another view of the 2×2 MIMO antenna of FIG. 1, including exemplary dimensions.

FIG. 3A is a zoomed in view of FIG. 2, providing detail on exemplary signal ports according to the disclosure.

FIG. 3B is a view similar to that of FIG. 3A, but showing solder caps on the exemplary signal ports.

### DESCRIPTION OF EXEMPLARY EMBODIMENTS

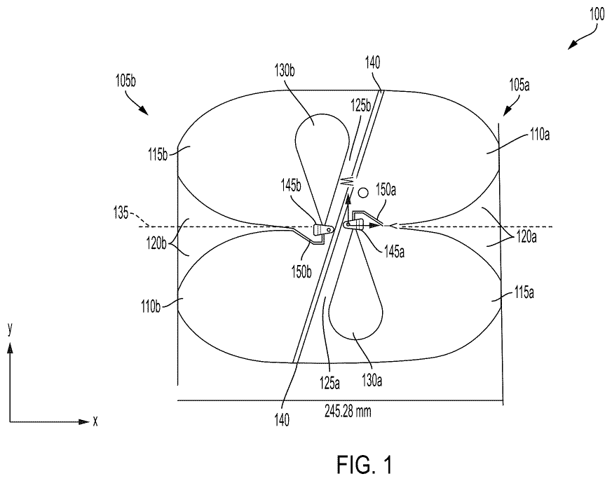

FIG. 1 illustrates an exemplary ultra-flat 2×2 MIMO broadband antenna structure (hereinafter “antenna”) 100 according to the disclosure. Antenna 100 has a right radiator 105a and a left radiator 105b. It will be understood that the terms “right” and “left” are arbitrary and used for the sake of description and do not necessarily indicate a right and left direction, except to indicate the energy radiated by the two radiators may be in opposite directions. Right radiator 105a and left radiator 105b are separated by a gap 140. Right radiator 105a is fed by a right signal port 145a and left radiator 105b is fed by a left signal port 105b.

It will be understood that the term ultra-flat may refer to an antenna that has a thickness of approximately 2 mm, although variations to this are possible, depending on the area of antenna 100.

Right radiator 105a has a first right radiator leaf 110a and a second right radiator leaf 115a, both of which are separated by a slot 150a, and both of which define an aperture of a Vivaldi radiator 120a. Vivaldi radiator 120a is defined by the opposing outward curvatures of first right radiator leaf 110a and second right radiator leaf 115a. RF (Radio Frequency) energy radiated by Vivaldi radiator 120a propagates along centerline axis 135 in the positive x direction. Second right radiator leaf 115a has a lobe-shaped cavity open region 130a that further defines a conductor channel 125a. Cavity open region 130a may mitigate current reflections from reflecting off the boundary of second right radiator leaf 115a and back toward right port 145a.

Left radiator 105b has a first left radiator leaf 110b and a second left radiator leaf 115b, both of which are separated by a slot 150b, and both of which define an aperture of a Vivaldi radiator 120b. Vivaldi radiator 120b is defined by the opposing outward curvatures of first left radiator leaf 110b and second left radiator leaf 115b. RF (Radio Frequency) energy radiated by Vivaldi radiator 120b propagates along centerline axis 135 in the negative x direction. Second left radiator leaf 115b has a lobe-shaped cavity open region 130b that further defines a conductor channel 125b. Cavity open region 130b may mitigate current reflections from reflecting off the boundary of second left radiator leaf 115b and back toward left port 145b.

First right radiator leaf 110a may have a shape that substantially (inversely) mirrors the shape of first left radiator 110b; and second right radiator 115a may have a shape that substantially (inversely) mirrors the shape of second left radiator 115b, as illustrated in FIG. 1.

Gap 140 may be canted at an angle such that it is not orthogonal to centerline axis 135. This enables a design for right radiator 105a and left radiator 105b to be maximized in area to ensure maximum operational bandwidth while still maintaining good port isolation between right radiator 105 a and left radiator 105 b. Gap 140 may have a width of, for example, 4.4 mm in width to achieve port isolation of greater than 14 dB across the operation band, a deemed good isolation.

Two variations to antenna 100 are discussed herein: a transparent version in which the ultra-flat antenna is disposed on a transparent substrate, and an opaque version in which the ultra-flat antenna is disposed on an opaque substrate.

For the transparent version of antenna 100, a transparent conductor may be used to form first right radiator leaf 110a and second right radiator leaf 115a of right radiator 105a, and first left radiator leaf 110b and second left radiator leaf 115b of left radiator 105b. The transparent conductor may be a thin copper mesh, such has Kodak's EKTAFLEX line of transparent conductive copper mesh, although other similar films may be used provided that they are sufficiently conductive to enable current flow to radiate RF energy as a broadband antenna element. In this example, the transparent copper mesh may be disposed on a backing film (not shown), such as polyester film. An exemplary material for backing film may be PET (polyethylene terephthalate), although any RF material, such as a Teflon-based material, may be used. The backing film may in turn be disposed on a substrate 160, which may be formed of polycarbonate or glass. The backing film may enable etching of the transparent conductor into desired patterns, such as the arrangement of first right radiator leaf 110a and second right radiator leaf 115a of right radiator 105a, and first left radiator leaf 110b and second left radiator leaf 115b of left radiator 105b. In an exemplary embodiment, a substrate 160 of polycarbonate such as Lexan, which may have standard thicknesses in the range, but not exclusive: 1/16^{th} inch to ½ inch; and backing film may have a thickness of 0.127 mm.

For the opaque version of antenna 100, substrate 160 may be formed of a glass-reinforced epoxy laminate, such as FR4 or other Teflon-based material. The antenna 100 may be used in applications where it is to be painted or covered by a thin film material, such as 3M wrap, to decorate or camouflage. Further to this version, first right radiator leaf 110a and second right radiator leaf 115a of right radiator 105a, and first left radiator leaf 110b and second left radiator leaf 115b of left radiator 105b may all be formed of a thin solid copper conductor.

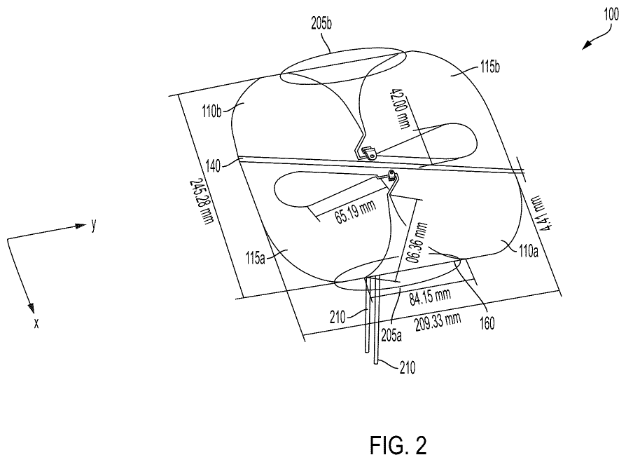

FIG. 2 is another view of antenna 100, rotated to show further details and providing exemplary dimensions. Illustrated are Vivaldi radiator mouths 205a and 205b formed by right radiator 105a and left radiator 105b, respectively. The width of Vivaldi radiator mouth 205a and 205b (84.15 mm in the exemplary embodiment illustrated in FIG. 2), along with the overall size of right radiator 105a and left radiator 105b, determine the low frequency of the operating frequency range of antenna 100. In the illustrated exemplary embodiment, the low frequency of the operating range is 617 MHz. The high frequency of the operating frequency range is a function of the width of the slot at the inner “throat” of each Vivaldi radiator 120a and 120b, which may be 1 mm or greater. In the illustrated exemplary embodiment, the high frequency of the operating range is 6 GHz.

Further illustrated are two RF cables 210, each of which couples to respective port 145a and 145b. Each RF cable 210 may be a 141 standard cable, although variations are possible and within the scope of the disclosure, depending on the amount of RF power being transmitted through cable 210 and the transmitted frequency range.

The dimensions shown are exemplary for the opaque version of antenna 100 in which the substrate 160 is formed of FR4. For a transparent version in which substrate 160 is formed of a polycarbonate, the shapes of first right radiator leaf 110a and second right radiator leaf 115a of right radiator 105a, and first left radiator leaf 110b and second left radiator leaf 115b of left radiator 105b, may be the same, but the dimensions may scale up slightly, due to the differences in dielectric constants between FR4 and a transparent polycarbonate. In the transparent variation, the dimensions may scale up 5-10%. Further, the dimensions provided in FIG. 2 are exemplary and that variations to these dimensions are possible depending on the desired operating frequency range. It will be understood that such variations are possible and within the scope of the disclosure.

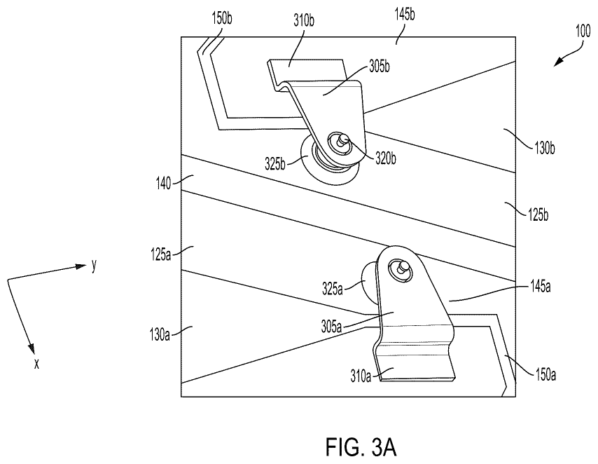

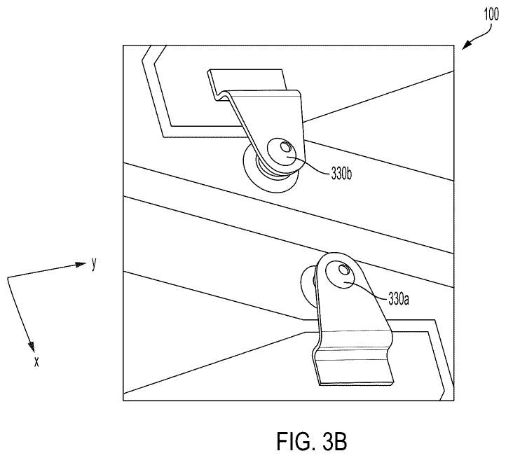

FIG. 3A is a zoomed in view of FIG. 2, providing further detail of ports 145a and 145b as they are coupled to respective right radiator 105a and left radiator 105b. In the case of right radiator 105a, port 145a has a ground solder joint 325a that electrically couples the outer conductor of RF cable 160 (not shown FIG. 3A) to conductor channel 125a that couples first right radiator leaf 110a to second right radiator leaf 115a. Port 145a has a conductor bridge 305a that has an inner conductor solder pad 320a, which electrically couples an inner conductor of RF cable 160 to conductor bridge 305a. Conductor bridge 305a further couples the RF signal from inner conductor solder pad 320a to second right radiator leaf 115a. Conductor bridge 145a bridges slot 150a, which separates first right radiator leaf 110a from second right radiator leaf 115a and is electrically and mechanically coupled to second right radiator leaf 115a at joint 310a. Port 145a may be located over slot 150a where it opens into lobe-shaped cavity open region 130a.

Although the above discussion of FIG. 3A focuses on right radiator 105a, it will be understood that the same description applies to left radiator 105b.

FIG. 3B is a similar view as that of FIG. 3A, but illustrating ports 145a/b, each having a solder cap 330a/b disposed on respective inner conductor solder pads 320a/b.

Variations to ports 145a/b are possible. Examples of variations to ports 145a/b are described in co-owned U.S. patent application Ser. No. 17/845,102, TRANSPARENT BROADBAND ANTENNA, which is incorporated by reference as if fully disclosed herein.

An advantage of antenna 100 is that, with two separate RF signals propagating in opposite directions, antenna 100 may be mounted on a wall, window, or ceiling, and provide two separate cell sectors within a given indoor space. This may enable antenna 100—and the base station to which it's connected-to cover twice the number of UEs (User Equipment) in a given space, which may be an indoor space or an outdoor space where dense pedestrian traffic is expected.

What is claimed is:

1. An antenna, comprising:
a first signal radiator disposed on a substrate, the first signal radiator having a first signal first radiator and a first signal second radiator, wherein the first signal first radiator and the first signal second radiator form a first Vivaldi radiator; and
a second signal radiator disposed on the substrate, the second signal radiator having a second signal first radiator and a second signal second radiator, wherein the second signal first radiator and the second signal second radiator form a second Vivaldi radiator.

2. The antenna of claim 1, where the first signal radiator comprises a first signal port that couples an RF (Radio Frequency) cable outer conductor to the first signal second radiator and couples an RF cable inner conductor to the first signal first radiator.

3. The antenna of claim 1, wherein the first signal first radiator and the first signal second radiator are electrically coupled by a conductor channel.

4. The antenna of claim 1, wherein the first Vivaldi radiator and the second Vivaldi radiator are physically oriented relative to each other so as to radiate in opposite directions.

5. The antenna of claim 4, wherein the first Vivaldi radiator and the second Vivaldi radiator radiate along a centerline axis between the first signal first radiator and the first signal second radiator, which form an aperture in the first Vivaldi radiator, and between the second signal first radiator and the second signal second radiator, which form an aperture in the second Vivaldi radiator.

6. The antenna of claim 1, wherein the first signal radiator and the second signal radiator are separated by a gap.

7. The antenna of claim 6, wherein the first signal first radiator has a first shape that inversely mirrors a shape of the second signal first radiator.

8. The antenna of claim 7, wherein the first signal second radiator has a second shape that inversely mirrors a shape of the second signal second radiator.

9. The antenna of claim 1, wherein the first Vivaldi radiator has a shape and configuration that inversely mirrors the shape and configuration of the second Vivaldi radiator.

10. The antenna of claim 1, wherein the first signal second radiator comprises a cavity open region.

11. The antenna of claim 1, wherein the first signal radiator and the second signal radiator are disposed on a transparent substrate.

12. The antenna of claim 9, wherein the transparent substrate comprises a polycarbonate.

13. The antenna of claim 12, wherein the first signal radiator and the second signal radiator comprise a copper mesh.

14. The antenna of claim 1, wherein the first signal radiator and the second signal radiator are disposed on an opaque substrate.

15. The antenna of claim 14, wherein the opaque substrate comprises a glass-reinforced epoxy laminate.

16. The antenna of claim 15, wherein the first signal radiator and the second signal radiator comprise a solid copper conductor.

17. An antenna comprising:
a first radiator having a rounded end; and
a second radiator separated from the first radiator by a slot, the second radiator having a rounded end,
wherein the rounded end of the first radiator and the rounded end of the second radiator are oriented relative to each other to form an aperture of a Vivaldi radiator;
wherein the second radiator has formed therein a lobe-shaped open region, the lobe-shaped open region forming a conductor channel on a side of the second radiator opposite the rounded end, and
wherein the configuration of the first radiator and the second radiator cause radio frequency (RF) energy to propagate through the aperture.

18. The antenna of claim 17 further comprising an antenna port, wherein the lobe-shaped open region is configured to mitigate current reflections from reflecting off a boundary of the second radiator toward the antenna port.

19. The antenna of claim 17, wherein the configuration of the first radiator and the second radiator propagates the RF energy along a centerline axis between the first radiator and second radiator.
